(19) United States
(12) Patent Application Publication
(10) Pub. No.: US 2007/0013244 A1
(43) Pub. Date: Jan. 18, 2007

(54) FRICTION DRIVE ELECTRICAL POWER CONVERTER APPARATUS AND PROCESS

(76) Inventor: Christopher P. Kinkaid, Portland, OR (US)

Correspondence Address: GREENBERG TRAURIG, 3773 HOWARD HUGHES PARKWAY, SUITE 500 NORTH, LAS VEGAS, NV, 89109, US

(21) Appl. No.: 11/457,135

(22) Filed: Jul. 12, 2006

Related U.S. Application Data
(60) Provisional application No. 60/698,095, filed on Jul. 12, 2005.

(51) Int. Cl. H02K 7/18; F03G 7/08

(52) U.S. Cl. 310/75 C; 290/1 R

(57) ABSTRACT

Described is a process and apparatus that converts the power contained within a moving vehicle when maintaining a motion on a surface, such as a vehicle moving on a street, into electricity to be used directly or stored in batteries to power a load. The specific invention, described herein, is a power converter that uses the motion of a moving platform or vehicle to derive electrical power using a described means of energy capture, transfer, and conversion. The specific invention uses friction and force transfer to capture forward or backward movements on a surface through friction, converts that kinetic energy into rotational torque, and generates useable electricity for the purposes of doing work.

### CROSS-REFERENCE TO PRIOR APPLICATIONS

This application claims the benefit of provisional Application No. 60/698,095 filed Jul. 12, 2005.

### FIELD OF THE INVENTION

The embodiments of the present invention relate to power converters, and more particularly to a process and an apparatus for converting kinetic energy into electrical energy for the purposes of doing work.

### BACKGROUND

Lighting and similar electrical systems can consume a great amount of electricity and energy. Some of these systems can run on batteries, others can run from a wall socket or a generator, and some can run on both. For mobile or portable systems, like a mobile billboard, batteries are the preferred method of creating power. Sometimes, generators may be needed onboard the mobile billboard platform to charge the batteries. The problem is that the brighter the lights, the larger the electrical output and consumption. And with rising energy costs, recharging batteries and generators can become an expensive cost of doing business. Furthermore, having large and powerful generators to run a lighting system on a mobile platform, such as a car or truck, can raise safety issues.

Consequently, there exists a need for a process and an apparatus for converting kinetic energy into electrical energy for either storage in one or more batteries to power a load or conversion directly into electricity to do work.

### SUMMARY

Accordingly, one embodiment of the present invention is a friction drive electrical power converter for a vehicle, comprising: a wheel; a shaft attached at one end to the wheel and fixed at a second end; a friction device for engagement with the wheel, the friction device operable when engaged with the wheel, to be driven by the wheel; a mechanical device operable to exert a normal force on the wheel; and an alternator connected to the friction device, the alternator operable to be driven by the friction device. The specific invention uses friction and force transfer to capture forward or backward movements on a surface through friction, converts that kinetic energy into rotational torque, and generates useable electricity for the purposes of doing work. In other embodiments, the shaft is not needed and the friction drive electrical power converter apparatus can be attached directly to the at least one wheel of a vehicle.

Other variations, embodiments and features of the present invention will become evident from the following detailed description, drawings and claims.

### BRIEF DESCRIPTION OF THE DRAWINGS

FIG. 1 illustrates a rear-view of one embodiment of a friction drive electrical power converter;

FIG. 2 illustrates a rear-view of another embodiment of a friction drive electrical power converter;

FIG. 3 illustrates a side-view of the friction drive electrical power converter of FIG. 2;

FIG. 4 illustrates a rear-view of yet another embodiment of a friction drive electrical power converter;

FIG. 5 illustrates a side-view of the friction drive electrical power converter of FIG. 4;

FIG. 6 illustrates a side-view of a plurality of friction drive electrical power converters of FIG. 4;

FIG. 7 illustrates a wiring diagram of a friction drive electrical power converter; and

FIG. 8 illustrates a battery's state of charge diagram.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

While the friction drive electrical power converter described below can be used with any moving vehicle, some reference is made to a mobile platform. The mobile platform may be used to support a mobile billboard and a system of lights for illuminating the billboard and depicted advertising.

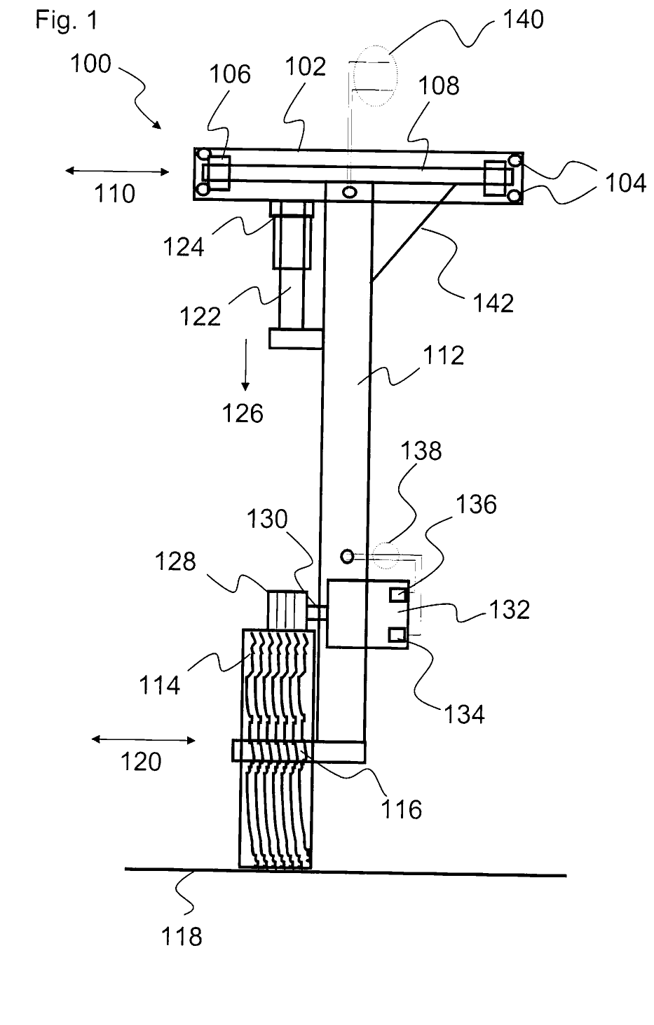

Initial reference is made to FIG. 1, which illustrates a rear-view of one embodiment of a friction drive electrical power converter 100. As shown, the friction drive electrical power converter 100 can be mounted to a mobile platform (not shown) via a mounting plate 102. The mounting plate 102 can be fastened underneath or behind a vehicle or trailer by known materials and methods. In a first embodiment, steel nuts and bolts 104 are used to attach the mounting plate 102 to the vehicle, trailer or mobile platform. A set of bearings 106 is attached to the mounting plate 102, such that an axle 108 may be concentrically mounted with an axis of rotation 110 about the bearings 106. Ideally, the bearings 106 are, but not limited to, double-sealed bearings. Attached to the axle 108 is a moment arm shaft 112, which freely rotates and extends from the mounting plate 102 about the axle 108 such that a full range of motion is provided about the axis of rotation 110. A wheel or tire 114 is coaxially attached at the other end of the moment arm shaft 112 through a wheel axle 116. Like the axle 108 on the mounting plate 102, the wheel axle 116 is also concentrically supported by two bearings (not shown). As the vehicle moves forward or backward, the wheel 114 makes physical contact with a road or rail surface 118, and turns or rotates about a wheel axis of rotation 120. Additionally, a rotational force or torque (T) is generated at the wheel axle 116 as the wheel 114 rolls over a surface 118.

A piston or shock absorber 122 as known in the art is attached to the mounting plate 102 with a mounting bracket 124 on one end and to the moment arm shaft 112 at the other end. The piston or shock absorber 122 may be filled with air or other gases. The piston or shock absorber 122 may also be hydraulic. The piston or shock absorber 122 provides dampening to minimize vibration experienced by the wheel 114 when it encounters uneven surfaces. In addition, the piston or shock absorber 122 also produces a downward compression or normal force 126 on the moment arm shaft 112. As a result of the normal force 126, the wheel 114 is compressed or forced to maintain constant physical contact with the surface of the ground 118 and non-contact is mitigated when the wheel 114 encounters debris, obstacles, or other rough terrain.

A friction roller 128 made of aluminum, steel, or other known material physically engages the wheel 114 of the friction drive electrical power converter 100. In a first embodiment, the friction roller 128 is lathed or milled out of a section of an aluminum cylinder with a 3″ diameter. One end of the friction roller 128 is coaxially mounted onto an axle shaft 130 of an alternator 132, while the opposite end may be capped. The friction roller 128 facilitates a change in relative position by reducing frictional resistance to translational movement. In other words, because the friction roller 128 is in physical contact with the tire 114 as the tire 114 rolls along the road 118 and torque (T) is generated, the rotational force is transferred or translated from the tire 114 to the friction roller 128. Because the friction roller 128 is physically connected to the alternator 132 through the axle shaft 130, the friction roller 128 turns and drives the alternator 132 thereby generating electricity. Since the radius of the tire 114 and the friction roller 128 is different (the friction roller 128 normally has a smaller radius than the tire 114), the friction roller 128 turns or rotates faster (more revolutions per minute) than the tire 114. Calculations can be made to optimize the performance of the friction drive electrical power converter 100 by determining the proper radius ratio. Ideally, the alternator 132 is a direct current (DC) electric generator as known in the art, or a multiplicity of alternating current (AC) generators and alternators including but not limited to self-exciting alternators, permanent magnetic alternators and other friction drive electrical power converters as known in the art. The alternator 132 can also be equipped with internal and external voltage regulators (not shown) and attached to storage devices such as batteries or other direct loads (not shown).

As described earlier, when the friction drive electrical power converter 100 is dragged or propelled by a moving platform, trailer or vehicle along a surface 118, the wheel 114 rotates. And as the wheel 114 rotates, the friction roller 128 also rotates thereby driving the alternator 132 producing electricity that may be transmitted by a negative terminal 134 and a positive terminal 136. Specifically, electrical wires 138 running along the length of the moment arm shaft 112 are used to transmit the electricity produced by the terminals 134, 136 to their respective negative and positive leads 140. The negative and positive leads 140 can be attached to power an instantaneous electrical load or a storage battery (not shown). Additionally, a structural gusset 142 can be installed between the moment arm shaft 112 and the axle 108 of the mounting plate 102 to provide further mechanical support. The embodiments as previously described are primarily intended for outdoor use in all climates and environments.

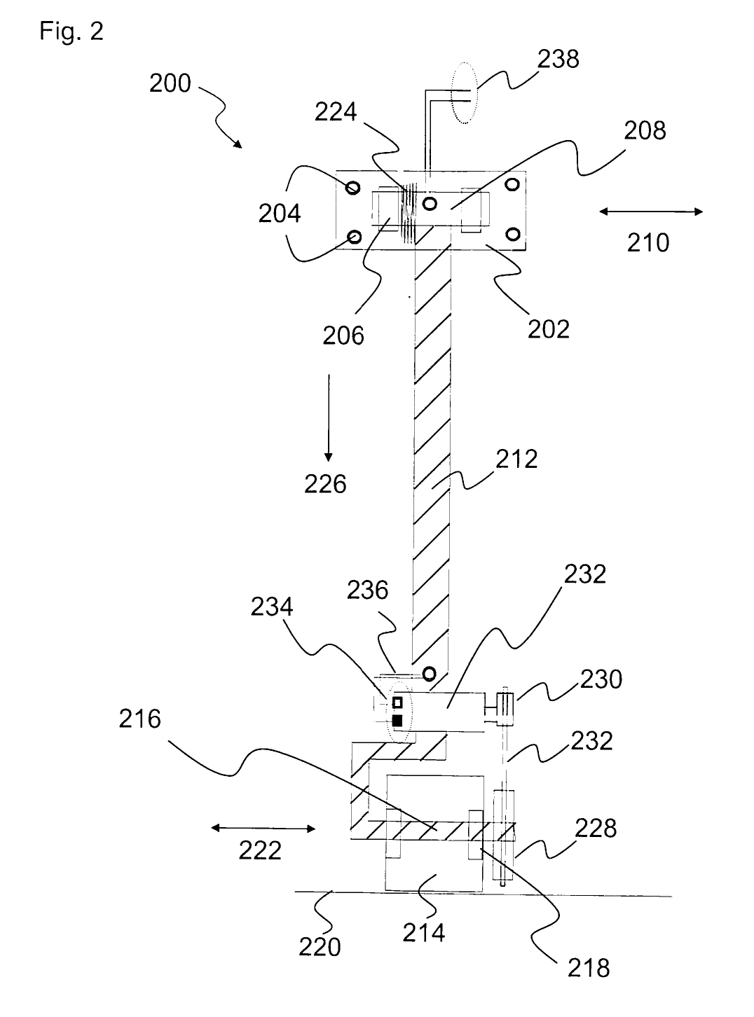

FIG. 2 illustrates a rear-view of another embodiment of a friction drive electrical power converter 200. As shown, the friction drive electrical power converter 200 can be mounted to a mobile platform (not shown) via a mounting plate 202. The mounting plate 202 can be fastened underneath or behind a vehicle or trailer by known materials and methods. In one embodiment, steel nuts and bolts 204 are used to attach the mounting plate 202 to the vehicle, trailer, or mobile platform. A set of bearings 206 is attached to the mounting plate 202, such that an axle 208 may be concentrically mounted with an axis of rotation 210 about the bearings 206. The bearings 206 are ideally, but not limited to, double-sealed bearings. Attached to the axle 208 is a moment arm shaft 212, which freely rotates and extends from the mounting plate 202 about the axle 208 such that a range of motion is provided about the axis of rotation 210. A wheel or tire 214 is coaxially attached at the other end of the moment arm shaft 212 through a wheel axle 216, which is concentrically supported by two wheel bearings 218. As the vehicle moves forward or backward, the wheel 214 makes physical contact with a road or rail surface 220 and turns or rotates about a wheel axis of rotation 222. Additionally, a rotational force or torque (T) is generated at the wheel axle 216 as the wheel 214 rolls over a surface 220.

A spring 224, or other such means known in the art, can be attached between the mounting plate 202 and the moment arm shaft 212 for exerting a downward force 226 on the moment arm shaft 212. The spring 224 can be stretched or compressed. When the spring 224 is compressed, force is applied to displace the spring 224. The work to compress the spring 224 is transferred to the spring 224 as energy. When the spring 224 is stretched, force is exerted on objects attached at its ends, which in this case is the moment arm shaft 212. This force is the result of the stored energy being released. Since the spring 224 is attached above the moment arm shaft 212, the force exerted will be a downward or normal force 226. The downward compression or normal force 226 exerted on the moment arm shaft 212 forces the tire 214 to maintain constant physical contact with the surface of the ground 220 and prevents the wheel 214 from not contacting the ground 220 when the tire 214 encounters debris, obstacles or other rough terrain. In addition, the spring 224 also serves as a suspension device by dampening vibrations experienced by the wheel 214 when it encounters uneven surfaces 220.

As described earlier, when the tire 214 rolls along the road 220 and torque (T) is generated, the rotational force can be mechanically transferred or translated from one object to another if the objects are in physical contact. In this embodiment, the rotational force or torque (T) generated by the wheel 214 is transferred to a pulley wheel 228, which is attached to the wheel 214 about the same wheel axis 216. The wheel 214 can also transfer rotational torque (T) to the pulley wheel 228 through a transmission belt or gear or other means known in the art. Likewise, the rotational torque (T) can be further transferred to a third wheel 230 from the pulley wheel 228 through a transmission belt 232, whereby the third wheel 230 can be coaxially attached to an alternator 232. As a result of these rotational force or torque (T) transfers, the third wheel 230 turns and drives the alternator 232 thereby generating electricity. Although the third wheel 230 is illustrated, there may be more or fewer wheels 214, 228, 230 incorporated within the friction drive electrical power converter 200.

In other embodiments, the alternator 232 may be a self-exciting alternator, a permanent magnet alternator or other electrical generators known in the art. The alternator 232 is fastened to the moment arm shaft 212 with a bracket and nuts and bolts, or with other known materials and methods. The alternator 232 has both negative and positive output terminals 234 whereby electrical wires 236 can extend through the moment arm shaft 212 and exit as respective negative and positive leads 238. The negative and positive leads 238 are attached to an electrical load (not shown), such as an instantaneous load or a storage battery for the purposes of doing work.

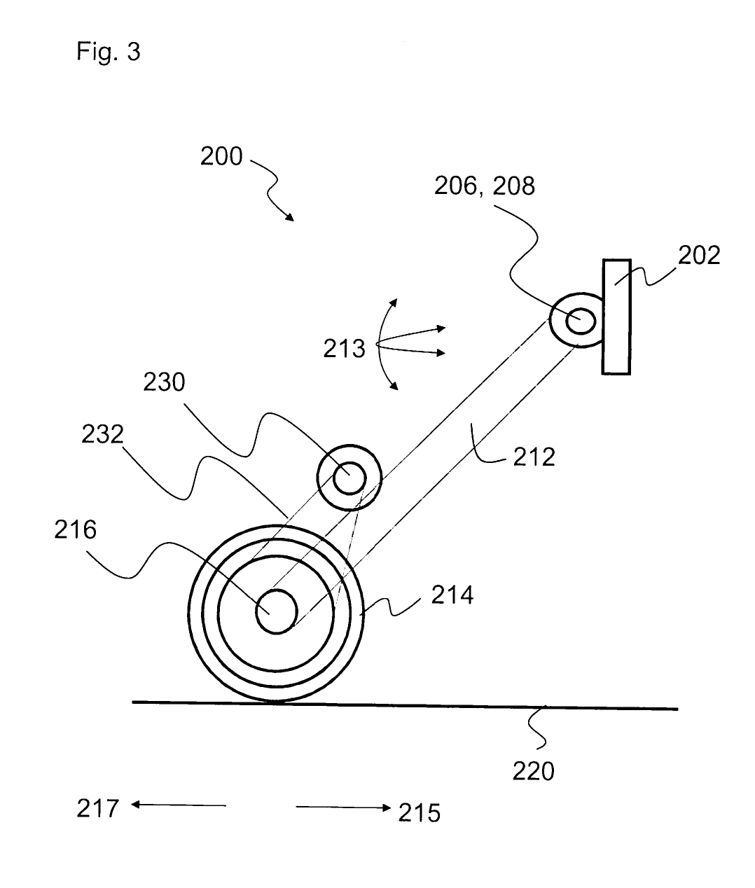

FIG. 3 illustrates a side-view of the friction drive electrical power converter 200 of FIG. 2. As shown, the friction drive electrical power converter 200 can be mounted to a moving device (not shown) via a mounting plate 202. For example, the mounting bracket 202 can be mounted to an I-beam of a truck or trailer by known materials and methods. Attached to the mounting bracket 202 are bearings 206 supporting a coaxial axle 208 similar to those described in FIGS. 1 and 2. A moment arm shaft 212 extends from the axle 208 to a wheel or tire 214. A range of motion is provided for the moment arm shaft 212 to rotate about the axle 208 as indicated by element 213, with the bearings 206 providing the pivot points thereby allowing the wheel 214 to move up and down 213 or from side to side 213. As illustrated in this figure, the friction drive electrical power converter 200 can freely change angles in response to changing road or surface conditions by pivoting off of the bearings 206. A rotational force or torque (T) is generated by the tire 214 as the truck or trailer moves forward 215 or backward 217.

The wheel 214 is coaxially attached to an axle 216, which is subsequently attached to a second wheel 230 through a gear or transmission belt 232. The second wheel 230 can be attached to an alternator (not shown) through an axle or a shaft (not shown) and mounted on the moment arm shaft 212 as described in FIGS. 1 and 2 (the second wheel 230 is shown to be slightly off-axis from the moment arm shaft 212 for illustration purposes). Like FIGS. 1 and 2, a spring, piston, or the likes (not shown) can be constructed on the moment arm shaft 212 to exert additional downward or normal force on the wheel 214. In normal operation, if the truck (not shown) moves forward 215, the wheel 214 rotates clock-wise, and if the truck moves backward 217, the wheel 214 rotates counter-clockwise. Angular velocity (v), or rate of change of angular displacement, is a function of speed. A vehicle traveling at a high rate of speed has rapidly rotating wheels 214, while a slower moving vehicle has slowly rotating wheels. Therefore, increased road speed results in increased electrical power generation. Also, as previously indicated, the amount of rotational force or torque (T) generated is a function of wheel radius 214. Thus, a wheel 214 with a larger radius makes fewer revolutions or turns per minute while a wheel 214 with a smaller radius rotates faster and drives the alternator faster. The amount of electrical power generated can be optimized by both wheel radius and the speed of travel.

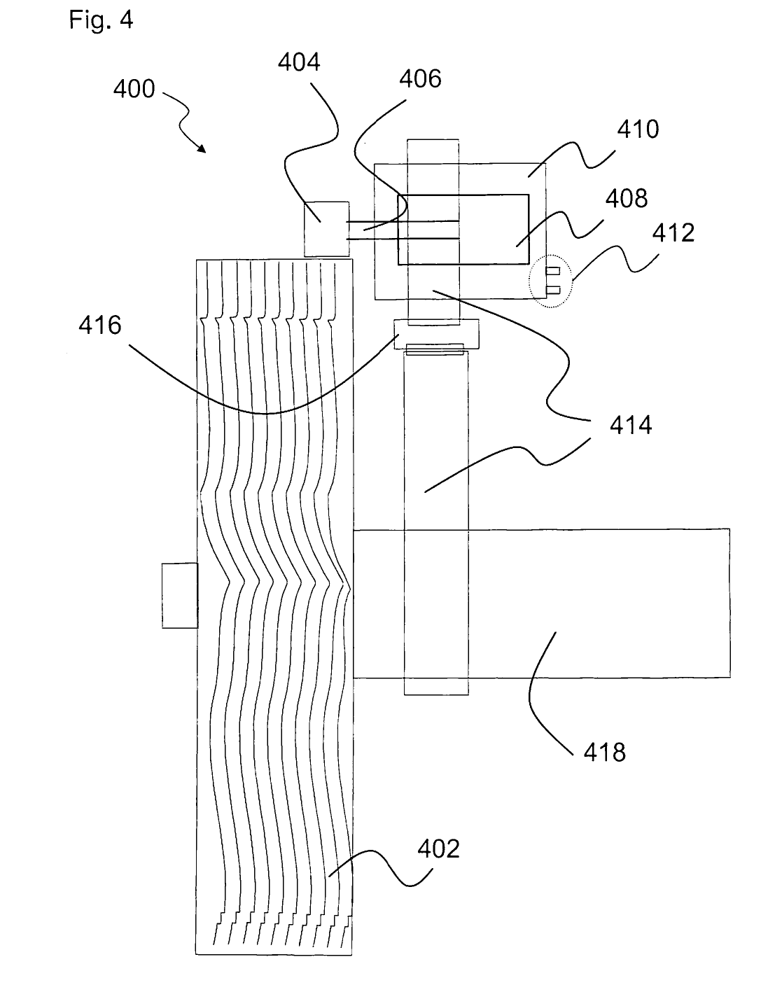

FIG. 4 illustrates a rear-view of yet another embodiment of a friction drive electrical power converter 400. As shown, the friction drive electrical power converter 400 can be mounted to a mobile platform (not shown), more specifically, the friction drive electrical power converter 400 can be mounted to an existing wheel or tire 402 of a vehicle, trailer, or a hitch mount. Like FIG. 1, a textured or un-textured friction roller 404 made of aluminum, steel, or other known material is designed to physically engage the wheel 402 of the vehicle. In one embodiment, the friction roller 404 is coaxially mounted to an alternator 408 through an alternator shaft 406. The alternator shaft 406 maintains equal distance between the tire 402 and the alternator 408. A frame 410 is used to support and house the alternator 408, and to provide additional grounding. The frame 410 can be mounted to the vehicle's frame, body, or undercarriage by known materials and methods. Output terminals 412 on the alternator 408 deliver the electricity produced to an electrical load by methods described in the previous figures.

Two support brackets 414 joined by a hinge 416 are used to further support the alternator frame 410 and to secure the alternator frame 410 onto an axle 418 of the rolling wheel 402. The hinge 416 articulates the two support brackets 414. Alternatively, a piston or shock absorber (not shown) known in the art may be used in place of the brackets 414. In addition to the weight of the vehicle exerting a compressive force on the wheel 402, the piston or shock absorber dampens and further applies an additional normal force on the wheel 402 by the methods previously described.

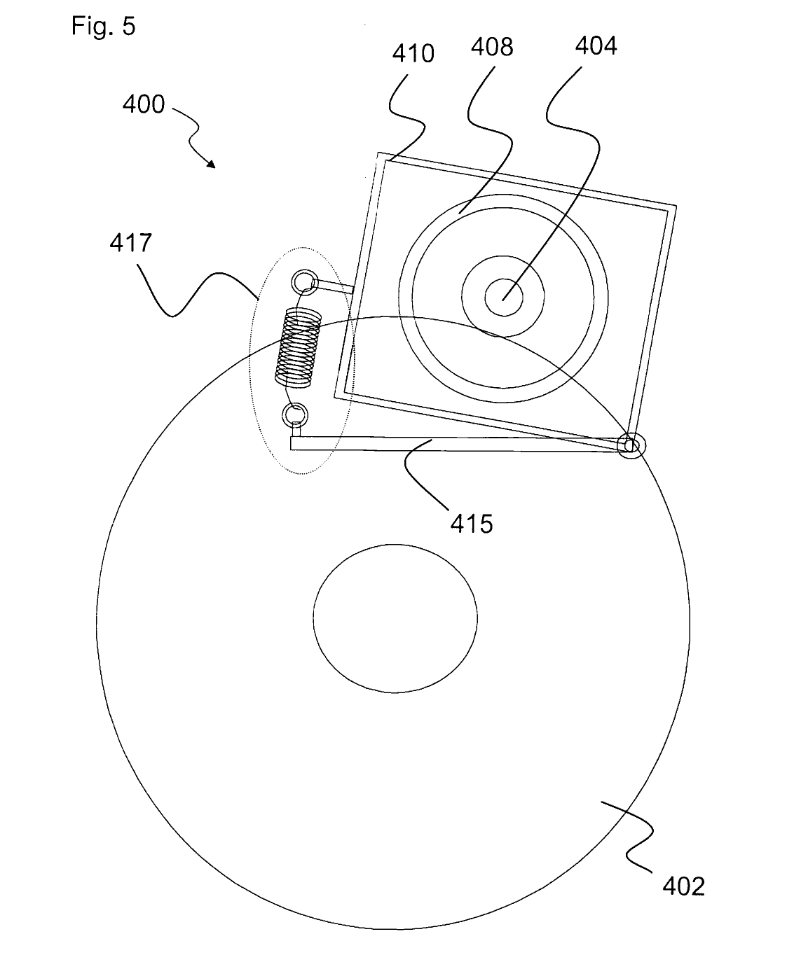

FIG. 5 illustrates a side-view of the friction drive electrical power converter 400 of FIG. 4. As shown, the friction drive electrical power converter 400 can be directly mounted to an existing wheel or tire 402 on a vehicle, trailer, or mobile platform (not shown). A textured or un-textured friction roller 404 is physically engaged with the wheel 402 and coaxially mounted to an alternator 408 through an alternator shaft (not shown). A frame 410 is used to house and support the alternator 408, which can be mounted to the vehicle's frame, body, or undercarriage through a mounting base plate 415. The friction roller 404 is adjustable and can be modified or changed as needed. To maintain physical contact between the friction roller 404 and the wheel 402, a spring system 417 can be installed to provide a compressive or normal force and compel the friction roller 404 to engage the wheel 402. Instead of the spring system 417, a physical screw or a pneumatic piston or shock absorber (not shown) can also be used. If a pneumatic piston is used, an additional bracket may have to be constructed to house the piston for forcing the friction roller 404 to engage the wheel 402. Other methods of controlling or maintaining the contact between the tire 402 and the friction roller 404 include solenoids (not shown), which upon signaling from a car brake light cause the two objects 402, 404 to make solid contacts. With an electric vehicle, the friction roller 404 may only be engaged with the car tire when the car is braking or going downhill.

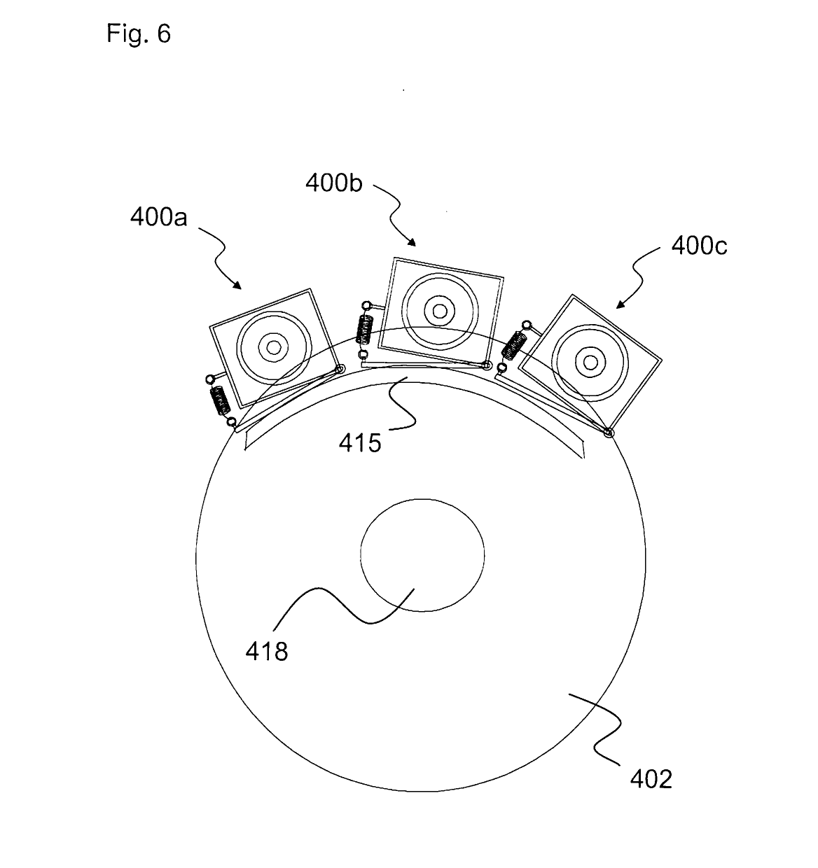

FIG. 6 illustrates a plurality of friction drive electrical power converter 400 of FIG. 4 on a wheel or tire 402 of a vehicle (not shown). As shown, three friction drive electrical power converters 400a, 400b, 400c generate increased power and energy output during operation. A mounting bracket 415 is used to attach the three friction drive electrical power converters 400a, 400b, 400c to struts and subsequently to an axle 418 of the wheel 402. Additionally, the three friction drive electrical power converters 400a, 400b, 400c may be mounted to other suitable places of the vehicle with known materials and methods. Furthermore, although three friction drive electrical power converters 400a, 400b, 400c are illustrated, there may be more or fewer converters depending on the size of the tire 402 and the availability of space underneath or around a vehicle.

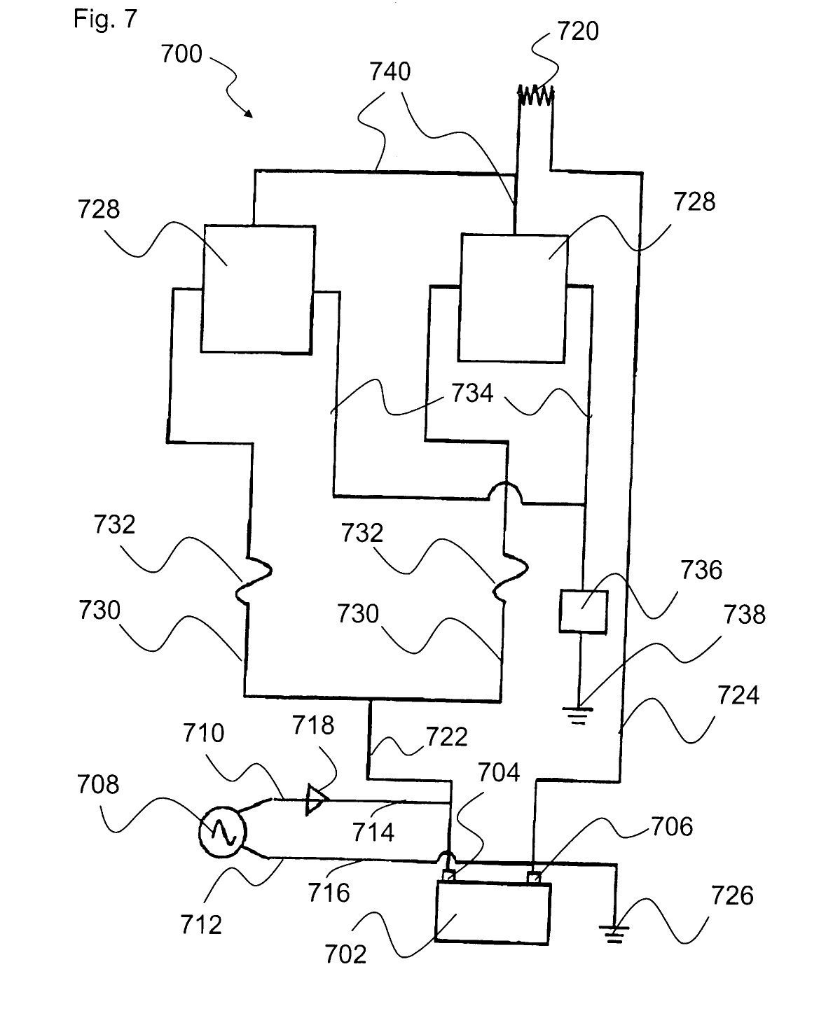

FIG. 7 shows a wiring diagram 700 used to power a load on demand and to provide a source of electrical power generation when a previously described friction drive electrical power converter is used by a moving vehicle, trailer, or platform. An electric battery 702 with positive 704 and negative 706 terminals can be charged by electricity-producing, friction drive electrical power converter 708 with a positive terminal 710 and a negative terminal 712. The negative terminal 712 is connected by wire 716 to the negative terminal 706, while the positive terminal 710 is connected by wire 714 to the positive terminal 704, in parallel with a blocking diode 718 that is inline with the wire 714 to prevent back flow of voltage from the storage battery 702 and the friction drive electrical power converter 708. The electricity produced by the friction drive electrical power converter 708 can be stored in the battery 702 or used to power an electrical load 720 through a positive output 722 and a negative output 724 with necessary grounding 726 to a vehicle's frame (not shown).

In this example, the positive output 722 is split between two relays 728 along two wires 730. Fuses 732 properly sized for the battery 702 and the electrical load 720 are necessary to protect the system 700 from over-current or over-loading conditions. Negative terminals 734 from the relays 728 are combined at a control switch 736, which can subsequently be grounded 738 to the frame of the vehicle. The control switch 736 connected to the two relays 728 controls the on/off condition for the load circuit 720. The types of load circuit 720 include systems such as lighting, powering electrical equipment or any other electrical loads such as an electrolyser, and other electrical, chemical, or mechanical loads. When the control switch 736 turns on, relays 728 have bias open white wires 730 on the positive sides of the relay and bias open black output wires 734 that complete the circuit to ground 738, thereby delivering electricity from output wires 740 to the electrical load 720. When the control switch 736 turns off, the black output wires 734 are denied proper grounding 738 thereby failing to complete the circuit.

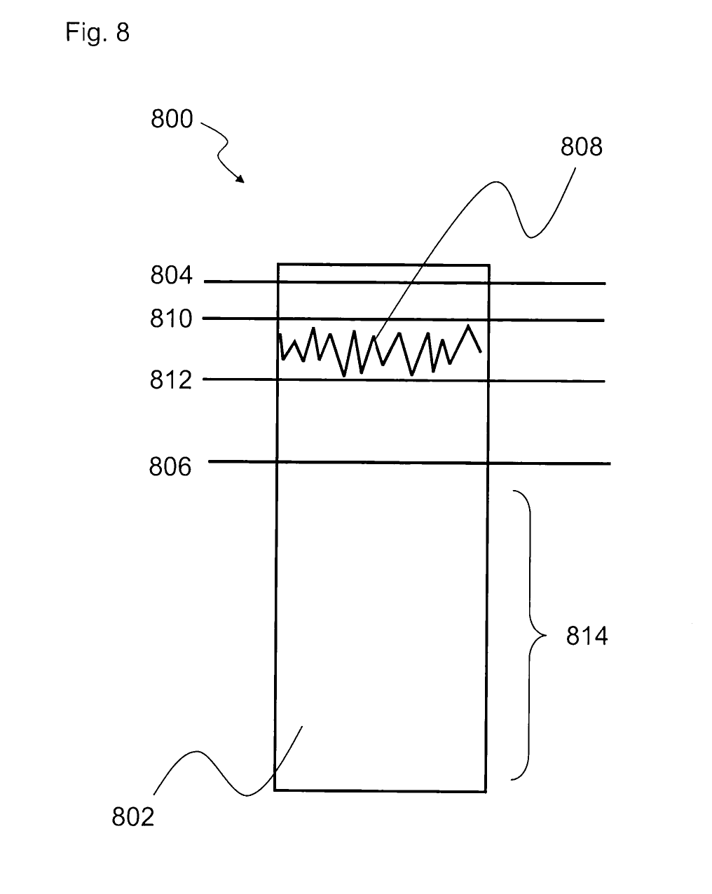

FIG. 8 illustrates a battery's state of charge diagram 800 when a power supply is used to charge a battery. The battery 802 has a maximum voltage 804 as allowed depending on the type of battery used including, but not limited to, flooded lead acid batteries and gel cell lead acid batteries. The maximum voltage 804 of a battery, shown here as a common 12 volt direct current cell, but not limited to this material or voltage, contains 14.5 volts of direct current for the purposes of this disclosure. A minimum voltage 806 represents the lowest voltage supported by the battery 802 before degradation occurs, and is represented by 11.5 volts direct current in this diagram 800. Within the maximum voltage 804 and the minimum voltage 806 is a preferred range for the battery 802 to charge and discharge 808 depending on the optimum number of cycles and discharge rates. An ideal maximum voltage 810 is 13.5 volts direct current while a preferred minimum voltage 812 is 12.0 volts direct current. Cycling 808 between the draw of a load and the charges resulting from applying a friction drive electrical power converter can be powered by the friction drive electrical power converter working within the preferred voltages 810, 812 of a battery storage system 802. A battery's state of charge, internal resistance, and temperature are kept in optimal conditions with the use of a properly sized and configured friction drive electrical power converter. The power and energy function 808 describes the proper use of the specific embodiments as a process and apparatus for converting surface friction from moving vehicles and platforms on roads and rails into electrical power suitable to perform work directly or to charge electrical storage batteries.

If an alternator is used as a friction drive electrical power converter within a friction drive electrical power converter, a rectifier may be needed to convert the 3-phase output from an alternating current to a direct current in order to function with a battery. Additionally, internal and external voltage regulators may also be used to prevent a battery from over-current or over-loading. By using an internal voltage regulator on the alternator, the friction drive electrical power converter better responds to the real condition of the state of charge of an electrical load. For example, when the battery is fully charged, the alternator senses it as a very small load and does not produce much current into the battery to keep it from overcharging. If the battery is really low, the alternator allows current to be pushed into the battery in order to fully charge it. Fuses, relays, and trigger switches can also be used to turn an electrical load on and off as needed, and to protect all components of the system since the system is mostly driven by voltage. Additionally, the specific invention may be combined with solar and wind generators to provide multiple power inputs for a battery or direct use system on vehicles and trailers.

Although the invention has been described in detail with reference to several embodiments, additional variations and modifications exist within the scope and spirit of the invention as described and defined in the following claims.

I claim:

1. A friction drive electrical power converter apparatus for a vehicle, comprising:
a wheel;
a shaft attached to the wheel and fixed at an opposite end;
a friction device for engagement with the wheel, the friction device operable, when engaged with the wheel, to be driven by the wheel;
a mechanical device operable to exert a normal force on the wheel, and
an alternator connected to the friction device, the alternator operable to be driven by the friction device.

2. The apparatus of claim 1, wherein the shaft is operable to move through a free range of motion about an axis of rotation.

3. The apparatus of claim 1, wherein the friction device is an aluminum roller or a steel roller.

4. The apparatus of claim 1, wherein the mechanical device is a piston, a shock absorber, or a spring.

5. The apparatus of claim 1, wherein the alternator is a self-exciting alternator, a permanent magnetic alternator or a direct current electric alternator.

6. The apparatus of claim 1, further comprising internal voltage regulators, external voltage regulators, batteries and direct electrical loads.

7. A friction drive electrical power converter apparatus for a mobile platform having at least one wheel, comprising:
a mechanical device attached to the mobile platform and to the at least one wheel through an axle, the mechanical device operable to exert a normal force on the at least one wheel;
a friction device for engagement with the at least one wheel, the friction device operable, when engaged with the at least one wheel, to be driven by the at least one wheel; and
an alternator connected to the friction device, the alternator operable to be driven by the friction device.

8. The apparatus of claim 7, wherein the friction device is an aluminum friction roller or a steel friction roller.

9. The apparatus of claim 7, wherein the mechanical device is a piston, a shock absorber or a spring.

10. The apparatus of claim 7, wherein the alternator is a self-exciting alternator, a permanent magnetic alternator, or a direct current electric alternator.

11. The apparatus of claim 7, further comprising internal voltage regulators, external voltage regulators, batteries and direct electrical loads.

12. A process for converting kinetic energy into electrical power on a vehicle having at least one wheel, comprising:
engaging a friction device with the at least one wheel the friction device operable to be driven by the at least one wheel;
exerting a normal force with a mechanical device, the mechanical device attached to a portion of the vehicle and to the at least one wheel through an axle of the at least one wheel; and
driving an alternator with the friction device driven by the at least one wheel, the alternator operable to convert rotational and translational forces into electricity.

13. The process of claim 12, wherein the friction device is an aluminum friction roller or a steel friction roller.

14. The process of claim 12, wherein the mechanical device is a piston, a shock absorber or a spring.

15. The process of claim 12, wherein the alternator is a self-exciting alternator, a permanent magnetic alternator or a direct current electric generator.

16. The process of claim 12, further comprising internal voltage regulators, external voltage regulators, batteries and direct electrical loads.

17. A friction drive electrical power converter apparatus for a vehicle, comprising:
a wheel;
a shaft attached to the wheel and to the vehicle;
a friction device for engagement with the wheel, the friction device operable, when engaged with the wheel, to be driven by the wheel; and
a pulley system for transferring rotational energy from the friction device to an alternator to create electricity.

18. The apparatus of claim 17 further comprising a mechanical device operable to exert a normal force on the wheel.

19. The apparatus of claim 18, wherein the mechanical device is a piston, a shock absorber, or a spring.

20. The apparatus of claim 17 further comprising internal voltage regulators, external voltage regulators, batteries and direct electrical loads.
